(19) United States
(12) Patent Application Publication
(10) Pub. No.: US 2026/0040172 A1
(43) Pub. Date: Feb. 5, 2026

(54) DATA COMMUNICATION

(71) Applicant: Nokia Technologies Oy, Espoo (FI)

(72) Inventors: Guillaume DECARREAU, Munich (DE); Subramanya CHANDRASHEKAR, Bangalore (IN); Srinivasan SELVAGANAPATHY, Bangalore (IN); Halit Murat GÜRSU, Munich (DE); Ahmad AWADA, Munich (DE)

(21) Appl. No.: 19/100,046

(22) PCT Filed: Jun. 23, 2023
(86) PCT No.: PCT/EP2023/067083

§ 371 Date: Jan. 30, 2025

(30) Foreign Application Priority Data
Aug. 2, 2022 (IN) 202241044244

(51) Int. Cl. H04W 36/08; H04W 36/00

(52) U.S. Cl. CPC H04W 36/087; H04W 36/0085

(57) ABSTRACT

The present disclosure relates to data communication. Certain examples provide User Equipment, UE, (110) for accessing a Radio Access Network, RAN, (100) comprising at least a central node (210) and a distributed node (220), the central node controlling the distributed node, wherein the UE comprises: at least one processor (12); and at least one memory (13) storing instructions (14) that, when executed by the at least one processor, cause the UE at least to: establish a connection towards the radio access network; receive (502), from the central node, a UE context modification request comprising: a request to change at least part of a lower layer configuration, and an identifier related to the request; perform (502) the requested change of the lower layer configuration; transmit (504), towards the central node. a confirmation that the requested change has been performed; and transmit (505), towards the distributed node, the identifier.

### TECHNOLOGICAL FIELD

Various examples of the present disclosure relate to the field of data communication, and in particular to: a user equipment, a distributed node, a central node and a system for data communication. Certain examples, though without prejudice to the foregoing, relate to: a user equipment, a distributed node, a central node and a system for use in Layer 1/Layer 2 based inter-cell mobility in a Radio Access Network.

### BACKGROUND

During conventional intra-gNB-Central Unit, CU, mobility in a Radio Access Network, RAN, a User Equipment, UE, moves from one cell of a gNB-CU to another cell of the gNB-CU. During conventional intra-gNB-CU mobility, a gNB-Distributed Unit, DU, of the gNB-CU that currently serves the UE hands over the serving of the UE to a new gNB-DU of the gNB-CU that is to start serving the UE. An intra-gNB-CU Handover, HO, procedure (which can also be referred to as an inter-gNB-DU HO procedure) is carried out to effect intra-gNB-CU mobility (which can also be referred to as inter-gNB-DU mobility).

Conventional intra-gNB-CU (inter-gNB-DU) HO procedures are not always optimal.

In some circumstances it can be desirable to provide improved data communication not least such as in intra-gNB-CU mobility.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any examples and features described in this specification that do not fall under the scope of the independent claims are to be interpreted as examples useful for understanding various embodiments of the invention.

According to at least some examples of the disclosure there is provided User Equipment, UE, for accessing a Radio Access Network, RAN, comprising at least a central node and a distributed node, the central node controlling the distributed node, wherein the UE comprises:
at least one processor; and
at least one memory storing instructions that, when executed by the at least one processor, cause the UE at least to:
   establish a connection towards the radio access network;
   receive, from the central node, a UE context modification request comprising:
      a request to change at least part of a lower layer configuration, and
      an identifier related to the request;
   perform the requested change of the lower layer configuration;
   transmit, towards the central node, a confirmation that the requested change has been performed; and
   transmit, towards the distributed node, the identifier.

According to various, but not necessarily all, examples of the disclosure there is provided a method for a User Equipment, UE, the method comprising causing, at least in part, actions that result in:
establishing a connection towards a Radio Access Network, RAN, wherein the RAN comprises at least a central node and a distributed node, the central node controlling the distributed node;
receiving, from the central node, a UE context modification request comprising:
   a request to change at least part of a lower layer configuration, and
   an identifier related to the request;
performing the requested change of the lower layer configuration;
transmitting, towards the central node, a confirmation that the requested change has been performed; and
transmitting, towards the distributed node, the identifier.

According to various, but not necessarily all, examples of the disclosure there is provided a chipset comprising processing circuitry configured to perform the above-mentioned method.

According to various, but not necessarily all, examples of the disclosure there is provided a module, circuitry, device and/or system comprising means for performing the above-mentioned method.

According to various, but not necessarily all, examples of the disclosure there is provided computer program comprising instructions which, when executed by an apparatus, cause the apparatus to perform the above-mentioned method.

According to various, but not necessarily all, examples of the disclosure there is provided a non-transitory computer readable medium encoded with instructions that, when executed by at least one processor, causes at least the following to be perform the above-mentioned method.

According to at least some examples of the disclosure there is provided User Equipment, UE, for accessing a Radio Access Network, RAN, comprising at least a central node and a distributed node, the central node controlling the distributed node, wherein the UE comprises:
means for establishing a connection towards the radio access network;
means for receiving, from the central node, a UE context modification request comprising:
   a request to change at least part of a lower layer configuration, and
   an identifier related to the request;
means for performing the requested change of the lower layer configuration;
means for transmitting, towards the central node, a confirmation that the requested change has been performed; and
means for transmitting, towards the distributed node, the identifier.

The following portion of this ‘Brief Summary’ section describes various features that can be features of any of the examples described in the foregoing portion of the ‘Brief Summary’ section mutatis mutandis. The description of a function should additionally be considered to also disclose any means suitable for performing that function.

In some but not necessarily all examples, the UE context modification request is received from the central node in, at least one selected from the group of:
a layer 3 protocol message;
a Radio Resource Configuration, RRC, message; and
an RRC Reconfiguration message.

In some but not necessarily all examples, the identifier is transmitted towards the distributed node, at least one selected from the group of:
via layer 2 signaling;
in a layer 2 protocol message; and
in a Medium Access Control, MAC, Control Element, CE.

In some but not necessarily all examples, the identifier is transmitted towards the distributed node, at least one selected from the group of:
via layer 1 signaling;
in Uplink Control Information, UCI;
in a Channel State Information, CSI, report; and
in a layer 1 measurement report.

In some but not necessarily all examples, the UE context modification request comprises an indicator for requesting the UE to confirm, to the distributed node, that the UE has performed the requested change; and wherein the UE is further configured to transmit, based at least in part on the received indicator, the identifier towards the distributed node for confirming to the distributed node that the UE has performed the requested change.

In some but not necessarily all examples, the indicator is: a flag or the identifier.

In some but not necessarily all examples, the identifier is:
an identifier for identifying the request;
a multibit identifier; or
a flag.

In some but not necessarily all examples, the requested change comprises a request for the UE to, at least one selected from the group of:
reconfigure the UE's lower layer protocol;
adjust a Layer 1, L1, measurement performed by the UE;
re-configure an L1 measurement report of the UE;
measure one or more beams of a target cell; and
report one or more measurements of one or more beams of a target cell.

According to at least some examples of the disclosure there is provided a distributed node of a Radio Access Network, RAN, comprising at least a central node and the distributed node, the central node controlling the distributed node, wherein the distributed node comprises:
at least one processor; and
at least one memory storing instructions that, when executed by the at least one processor, cause the distributed node at least to:
   receive a first User Equipment, UE, context modification request transmitted from the central node towards the distributed node, the first UE context modification request comprising:
      a request to change at least part of a lower layer configuration, and
      an identifier related to the request;
   receive a second UE context modification request transmitted from the central node towards the UE via the distributed node, the second UE context modification request comprising:
      a request to change at least part of a lower layer configuration, and the identifier;
   transmit the second UE context modification request towards the UE; and receive, from the UE, the identifier.

According to at least some examples of the disclosure there is provided a method for a distributed node of a Radio Access Network, RAN, comprising at least a central node and the distributed node, the central node controlling the distributed node, wherein the method comprises causing, at least in part, actions that result in:
receiving a first User Equipment, UE, context modification request transmitted from the central node towards the distributed node, the first UE context modification request comprising:
   a request to change at least part of a lower layer configuration, and
   an identifier related to the request;
receiving a second UE context modification request transmitted from the central node towards the UE via the distributed node, the second UE context modification request comprising:
   a request to change at least part of a lower layer configuration, and
   the identifier;
transmitting the second UE context modification request towards the UE; and receiving, from the UE, the identifier.

According to various, but not necessarily all, examples of the disclosure there is provided a chipset comprising processing circuitry configured to perform the above-mentioned method.

According to various, but not necessarily all, examples of the disclosure there is provided a module, circuitry, device and/or system comprising means for performing the above-mentioned method.

According to various, but not necessarily all, examples of the disclosure there is provided computer program comprising instructions which, when executed by an apparatus, cause the apparatus to perform the above-mentioned method.

According to various, but not necessarily all, examples of the disclosure there is provided a non-transitory computer readable medium encoded with instructions that, when executed by at least one processor, causes at least the following to be perform the above-mentioned method.

According to at least some examples of the disclosure there is provided a distributed node of a Radio Access Network, RAN, comprising at least a central node and the distributed node, the central node controlling the distributed node, wherein the distributed node comprises:
means for receiving a first User Equipment, UE, context modification request transmitted from the central node towards the distributed node, the first UE context modification request comprising:
   a request to change at least part of a lower layer configuration, and
   an identifier related to the request;
means for receiving a second UE context modification request transmitted from the central node towards the UE via the distributed node, the second UE context modification request comprising:
   a request to change at least part of a lower layer configuration, and the identifier;
means for transmitting the second UE context modification request towards the UE; and receive, from the UE, the identifier.

The following portion of this ‘Brief Summary’ section describes various features that can be features of any of the examples described in the foregoing portion of the ‘Brief Summary’ section mutatis mutandis. The description of a function should additionally be considered to also disclose any means suitable for performing that function.

In some but not necessarily all examples, the distributed node is further configured to determine, based at least in part on the identifier received from the UE, that the UE has performed the requested change.

In some but not necessarily all examples, the distributed node is further configured to transmit, towards the central node, a response to the first UE context modification request.

In some but not necessarily all examples, the response to the first UE context modification request comprises the identifier or a replacement identifier for identifying the request.

In some but not necessarily all examples, the distributed node is further configured to:
receive, from the UE for transmission towards the central node, a confirmation that the requested change has been performed; and
transmit, towards the central node, the confirmation.

In some but not necessarily all examples, the first UE context modification request comprises: a request to, at least one or more of:
reconfigure a lower layer protocol of the UE.
adjust an interpretation of a Layer 1, L1, measurement report received from the UE;
receive, from the UE, L1 measurements for a target cell;
associate one or more measurements, from a measurement report received from the UE, with of one or more beams of a target cell; and
hand over the UE to at least one selected from the group of:
   a target cell controlled by the distributed node;
   a target cell controlled by another distributed node; and
   one or more candidate target cells.

In some but not necessarily all examples, the first UE context modification request comprises a plurality of requested changes to the lower layer configuration, and wherein:
the identifier is configured to identify the plurality of requested changes, or
the identifier comprises a plurality of identifiers configured to identify the plurality of requested changes respectively.

In some but not necessarily all examples, distributed node is further configured to:
adjust an interpretation of a Layer 1, L1, measurement report received from the UE based at least in part on the identifier received from the central node; and/or
associate one or more measurements, from a measurement report received from the UE, with of one or more beams of a target cell based at least in part on the identifier received from the central node.

In some but not necessarily all examples, the distributed node is further configured to determine, based at least in part on the identifier received from the UE, whether one or more L1 measurements received from the UE are to be associated with at least one selected from the group of:
a target cell;
one or more candidate target cells;
one or more beams of a target cell; and
one or more beams of one or more candidate target cells.

In some but not necessarily all examples, the distributed node is further configured to:
determine to trigger the UE to execute a handover of the UE to a target cell, based at least in part on at least one selected from the group of:
   the identifier received from the UE; and
   an L1 measurement report received from the UE following receipt of the identifier from the UE.

In some but not necessarily all examples, the second UE context modification request is received from the central node in, at least one selected from the group of:
a layer 3 protocol message;
a Radio Resource Configuration, RRC, message; and
an RRC Reconfiguration message.

In some but not necessarily all examples, the identifier is received from the UE, at least one selected from the group of:
via layer 2 signaling;
in a layer 2 protocol message; and
in a Medium Access Control, MAC, Control Element, CE.

In some but not necessarily all examples, the identifier is received from the UE, at least one selected from the group of:
via layer 1 signaling;
in Uplink Control Information, UCI;
in a Channel State Information, CSI, report; and
in a layer 1 measurement report.

In some but not necessarily all examples, the second UE context modification request comprises an indicator for requesting the UE to confirm, to the distributed node, that the UE has performed the requested change; and wherein the distributed node is further configured to receive the identifier from the UE for confirming to the distributed node that the UE has performed the requested change.

In some but not necessarily all examples, the indicator is: a flag or the identifier.

In some but not necessarily all examples, the identifier is:
an identifier for identifying the request;
a multibit identifier; or
a flag.

In some but not necessarily all examples, the requested change of the second UE context modification request comprises a request for the UE to, at least one selected from the group of:
reconfigure the UE's lower layer protocol;
adjust a Layer 1, L1, measurement performed by the UE;
re-configure an L1 measurement report of the UE;
measure one or more beams of a target cell; and
report one or more measurements of one or more beams of a target cell.

According to at least some examples of the disclosure there is provided a central node of a Radio Access Network, RAN, comprising at least the central node and a distributed node, the central node controlling the distributed node, wherein the central node comprises:
at least one processor; and
at least one memory storing instructions that, when executed by the at least one processor, cause the distributed node at least to:
   generate an identifier associated with a request to change at least part of a lower layer configuration;
   transmit, towards the distributed node, a first User Equipment, UE, context modification request comprising:
      the request to change at least part of a lower layer, and
      the identifier; and
   transmit, towards the UE, a second UE context modification request comprising:
      a request to change at least part of a lower layer configuration, and the identifier.

According to at least some examples of the disclosure there is provided a method for a central node of a Radio Access Network, RAN, comprising at least the central node and a distributed node, the central node controlling the distributed node, the method comprising:
generating an identifier associated with a request to change at least part of a lower layer configuration;
transmitting, towards the distributed node, a first User Equipment, UE, context modification request comprising:
   the request to change at least part of a lower layer, and
   the identifier; and
transmitting, towards the UE, a second UE context modification request comprising:
   a request to change at least part of a lower layer configuration, and
   the identifier.

According to various, but not necessarily all, examples of the disclosure there is provided a chipset comprising processing circuitry configured to perform the above-mentioned method.

According to various, but not necessarily all, examples of the disclosure there is provided a module, circuitry, device and/or system comprising means for performing the above-mentioned method.

According to various, but not necessarily all, examples of the disclosure there is provided computer program comprising instructions which, when executed by an apparatus, cause the apparatus to perform the above-mentioned method.

According to various, but not necessarily all, examples of the disclosure there is provided a non-transitory computer readable medium encoded with instructions that, when executed by at least one processor, causes at least the following to be perform the above-mentioned method.

According to at least some examples of the disclosure there is provided a central node of a Radio Access Network, RAN, comprising at least the central node and a distributed node, the central node controlling the distributed node, wherein the central node comprises: means for generating an identifier associated with a request to change at least part of a lower layer configuration;
means for transmitting, towards the distributed node, a first User Equipment, UE, context modification request comprising:
   the request to change at least part of a lower layer, and
   the identifier; and
means for transmitting, towards the UE, a second UE context modification request comprising:
   a request to change at least part of a lower layer configuration, and
   the identifier.

The following portion of this ‘Brief Summary’ section describes various features that can be features of any of the examples described in the foregoing portion of the ‘Brief Summary’ section mutatis mutandis. The description of a function should additionally be considered to also disclose any means suitable for performing that function.

In some but not necessarily all examples, the central node is further configured to receive, from the distributed node, a response to the first UE context modification request.

In some but not necessarily all examples, the response to the first UE context modification request comprises the identifier or a replacement identifier for identifying the request.

In some but not necessarily all examples, the central node is further configured to:
receive, from the UE, a confirmation that the requested change has been performed.

In some but not necessarily all examples, the first UE context modification request comprises: a request to, at least one or more of:
reconfigure the distributed node's lower layer protocol.
adjust an interpretation of a Layer 1, L1, measurement report received from the UE;
receive, from the UE, L1 measurements for a target cell;
associate one or more measurements, from a measurement report received from the UE, with of one or more beams of a target cell; and
hand over the UE from a cell of the distributed node to at least one selected from the group of:
   a target cell, and
   one or more candidate target cells.

In some but not necessarily all examples, the first UE context modification request comprises a plurality of requested changes to the lower layer configuration, and wherein:
the identifier is configured to identify the plurality of requested changes, or
the identifier comprises a plurality of identifiers configured to identify the plurality of requested changes respectively.

In some but not necessarily all examples, the second UE context modification request is transmitted towards the UE in, at least one selected from the group of:
a layer 3 protocol message;
a Radio Resource Configuration, RRC, message; and
an RRC Reconfiguration message.

In some but not necessarily all examples, the second UE context modification request comprises an indicator for requesting the UE to confirm, to the distributed node, that the UE has performed the requested change.

In some but not necessarily all examples, the indicator is: a flag or the identifier.

In some but not necessarily all examples, wherein the identifier is:
an identifier for identifying the request;
a multibit identifier; or
a flag.

In some but not necessarily all examples, the requested change of the second UE context modification request comprises a request for the UE to, at least one selected from the group of:
reconfigure the UE's lower layer protocol;
adjust a Layer 1, L1, measurement performed by the UE;
re-configure an L1 measurement report of the UE;
measure one or more beams of a target cell; and
report one or more measurements of one or more beams of a target cell.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION OF THE DRAWINGS

Some examples will now be described with reference to the accompanying drawings in which:

FIG. 1 shows an example of the subject matter described herein;

FIG. 2 shows another example of the subject matter described herein;

FIG. 3 shows another example of the subject matter described herein;

FIG. 4 shows another example of the subject matter described herein;

FIG. 5 shows another example of the subject matter described herein;

FIG. 6 shows another example of the subject matter described herein;

FIG. 7 shows another example of the subject matter described herein;

FIG. 8 shows another example of the subject matter described herein, and

FIG. 9 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals may be used in the figures to designate similar features. For clarity, all reference numerals are not necessarily displayed in all figures.

In the drawings (and description) a similar feature may be referenced by the same three-digit number. In the drawings (and description), an optional subscript to the three-digit number can be used to differentiate different instances of similar features. Therefore, a three-digit number without a subscript can be used as a generic reference and the three-digit number with a subscript can be used as a specific reference. A subscript can comprise a single digit that labels different instances. A subscript can comprise two digits including a first digit that labels a group of instances and a second digit that labels different instances in the group.

### ABREVIATIONS/DEFINITIONS

5G Fifth Generations
CE Control Element
CU Central Unit/Central node
CSI Channel State Information
DL Downlink
DU Distributed Unit/Distributed node
gNB gNodeB
HO Handover
ID Identifier
L1 Layer 1
L2 Layer 2
L3 Layer 3
MAC Medium Access Control
NR New Radio
RAN Radio Access Network
RRC Radio Resource Configuration
UC Uplink Control Information
UE User Equipment
UL Uplink

### DETAILED DESCRIPTION

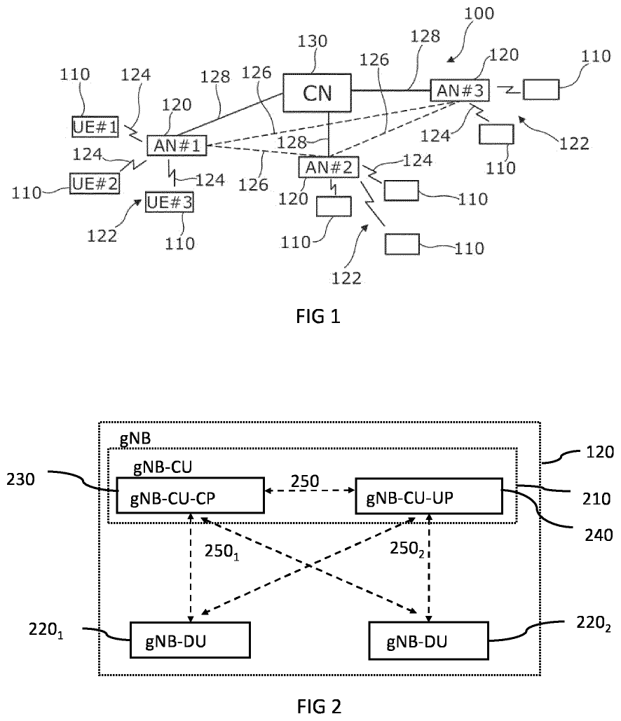

FIG. 1 schematically illustrates an example of a network 100 comprising a plurality of network nodes including terminal nodes 110 (also referred to as User Equipment, UE), access nodes 120 and one or more core nodes 130. The terminal nodes 110 and access nodes 120 communicate with each other. The access nodes 120 communicate with the one or more core nodes 130. The one or more core nodes 130 may, in some but not necessarily all examples, communicate with each other. The one or more access nodes 120 may, in some but not necessarily all examples, communicate with each other.

The network 100 is in this example a radio telecommunications network, i.e., a Radio Access Network, RAN, in which at least some of the terminal nodes 110 and access nodes 120 communicate with each other using transmission/reception of radio waves.

The RAN 100 may be a cellular network comprising a plurality of cells 122 each served by an access node 120. The access nodes 120 comprise cellular radio transceivers. The terminal nodes 110 comprise cellular radio transceivers.

In the particular example illustrated, the network 100 is a Next Generation (NG) or New Radio (NR) network. NR is the Third Generation Partnership Project (3GPP) name for Fifth Generation (5G) technology.

The interfaces between the terminal nodes 110 and the access nodes 120 are radio interfaces 124 (e.g., Uu interfaces). The interfaces between the access nodes 120 and one or more core nodes 130 are backhaul interfaces 128 (e.g., S1 and/or NG interfaces).

Depending on the exact deployment scenario, the access nodes 120 can be RAN nodes such as NG-RAN nodes. NG-RAN nodes may be gNodeBs (gNBs) that provide NR user plane and control plane protocol terminations towards the UE. NG-RAN nodes may be New Generation Evolved Universal Terrestrial Radio Access network (E-UTRAN) NodeBs (ng-eNBs) that provide E-UTRA user plane and control plane protocol terminations towards the UE. The gNBs and ng-eNBs may be interconnected with each other by means of Xn interfaces. The gNBs and ng-eNBs are also connected by means of NG interfaces to the 5G Core (5GC), more specifically to the AMF (Access and Mobility management Function) by means of the NG-C interface and to the UPF (User Plane Function) by means of the NG-U interface. The access nodes 120 may be interconnected with each other by means of Xn interfaces 126. The cellular network 100 could be configured to operate in licensed or unlicensed frequency bands, not least such as a 60 GHz unlicensed band where beamforming is mandatory in order to achieve required coverage.

The access nodes 120 can be deployed in a NR standalone operation/scenario. The access nodes 120 can be deployed in a NR non-standalone operation/scenario. The access nodes can be deployed in a Carrier Aggregation, CA, operation/scenario. The access nodes 120 can be deployed in a dual connectivity operation/scenario, i.e., Multi Radio Access Technology-Dual Connection (MR-DC), not least for example such as:
Evolved Universal Terrestrial Radio Access-New Radio Dual Connectivity (EUTRA-NR-DC, also referred to as EN-DC),
New Radio-Evolved Universal Terrestrial Radio Access Dual Connectivity (NR-EUTRA-DC, also referred to as NE-DC),
Next Generation Radio Access Network Evolved Universal Terrestrial Radio Access-New Radio Dual Connectivity (NG-RAN E-UTRA-NR Dual Connectivity, also referred to as NGEN-DC), or
New Radio Dual Connectivity (also referred to as NR-DC).

In such non-standalone/dual connectivity deployments, the access nodes 120 may be interconnected to each other by means of X2 or Xn interfaces, and connected to an Evolved Packet Core (EPC) by means of an S1 interface or to the 5GC by means of a NG interface.

The terminal nodes 110 are network elements in the network that terminate the user side of the radio link. They are devices allowing access to network services. The terminal nodes 110 may be referred to as User Equipment (UE), mobile terminals or mobile stations. The term ‘User Equipment’ may be used to designate mobile equipment comprising a smart card for authentication/encryption etc. such as a subscriber identity module (SIM). In other examples, the term ‘User Equipment’ is used to designate mobile equipment comprising circuitry embedded as part of the user equipment for authentication/encryption such as software SIM.

The access nodes 120 are network elements in the network responsible for radio transmission and reception in one or more cells 122 to or from the terminal nodes 110. Such access nodes may also be referred to as a transmission reception points (TRP's) or base stations. The access nodes 120 are the network termination of a radio link. An access node 120 can be implemented as a single network equipment, or disaggregated/distributed over two or more RAN nodes, such as a central unit (CU), a distributed unit (DU), a remote radio head-end (RRH), using different functional-split architectures and different interfaces.

In the following description, an access node will be referred to as gNB 120 and a terminal node 110 will be referred to as a UE 110.

FIG. 2 illustrates an example of an access node 120 (e.g., gNB). In this example, the access node has a disaggregated (split) architecture. The gNB 120 comprises one or more distributed units/distributed nodes (gNB-DU) 220 and a central unit/central node (gNB-CU) 210.

The gNB-CU 210 is a logical node, referred to as a central node, configured to host a Radio Resource Connection (RRC) layer and other layers of the gNB 120. The gNB-CU 210 controls the operation of one or more gNB-DUs 220. The gNB-DU 220 is a logical node, referred to as a distributed node, configured to host Radio Link Control (RLC) protocol layer, Medium Access Control (MAC) layer and Physical (PHY) layer of the access node (gNB) 120. The gNB-DU 220 communicates via a dedicated interface 250 (F1) to the RRC layer hosted by the gNB-CU.

One gNB-DU 220 can support one or multiple cells 122 (not illustrated in the figure). One cell is supported by only one gNB-DU 220.

The gNB-CU 210 and a gNB-DU 220 communicate via a dedicated interface 250, the F1 interface. The F1 interface 250 connects a Radio Resource Connection (RRC) layer hosted by the gNB-CU 210 to the different, lower layers (e.g. layer 1 and layer 2) hosted by the gNB-DU 220. The F1 interface functions are divided into F1-Control Plane Function (F1-C) 2501 and F1-User Plane Function (F1-U) 2502.

In the following description: a central unit of a gNB (i.e. gNB-CU) will be referred to as CU 210, a distributed unit of a gNB (i.e. gNB-DU) will be referred to as DU 220, and a terminal node 110 will be referred to as UE 110.

As discussed above, a gNB comprises a node providing NR user plane and control plane protocol terminations towards the UE. The gNB is connected via an NG interface to the 5GC, e.g. according to 3GPP TS 38.300 V16.6.0 (2021-06) section 3.2.

The CU comprises e.g. a logical node hosting e.g. RRC, SDAP and PDCP protocols of the gNB or RRC and PDCP protocols of an en-gNB that controls the operation of one or more DU. The CU terminates the F1 interface connected with the DU.

The DU comprises e.g. a logical node hosting e.g. RLC, MAC and PHY layers of the gNB or en-gNB, and its operation is partly controlled by the CU. One DU supports one or multiple cells. One cell is supported by only one DU. The DU terminates the F1 interface connected with the CU.

A CU-Control Plane (i.e. CU-CP) comprises e.g. a logical node hosting e.g. the RRC and a control plane part of the PDCP protocol of the CU for an en-gNB or a gNB. The CU-CP terminates an E1 interface connected with the CU-UP and the F1-C interface connected with the DU.

A CU-User Plane (i.e. CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.401 V16.6.0 (2021-07) section 3.1.

Different functional splits between the CU and DU are possible, e.g. called options:
Option 1 (1A-like split): The function split in this option is similar to a 1A architecture in DC. RRC is in the CU. PDCP, RLC, MAC, physical layer and RF are in the DU.
Option 2 (3C-like split): The function split in this option is similar to a 3C architecture in DC. RRC and PDCP are in the CU. RLC, MAC, physical layer and RF are in the DU.
Option 3 (intra RLC split): Low RLC (partial function of RLC), MAC, physical layer and RF are in the DU. PDCP and high RLC (the other partial function of RLC) are in the CU.
Option 4 (RLC-MAC split): MAC, physical layer and RF are in the DU. PDCP and RLC are in the CU.
Or else, e.g. according to 3GPP TR 38.801 V14.0.0 (2017-03) section 11.

A gNB supports different protocol layers, e.g. Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. to segmentation;
Control channels include (BCCH, PCCH).

Layer 3 (L3) includes e.g. Radio Resource Control (RRC), e.g. according to 3GPP TS 38.300 V16.6.0 (2021-06) section 6.

A RAN (Radio Access Network) node or network node or central node or distributed node (like e.g. a gNB, base station, CU or DU or parts thereof) may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3. They may also be implemented using specific means configured to perform respective specific tasks, e.g. layer 3 means to perform layer 3 operations, layer 2 means to perform layer 2 operations, etc.

The CU and DU parts may e.g. be co-located or physically separated. The gNB DU may even be split further, e.g. into two parts, e.g. one including processing equipment and one including an antenna. A CU may also be called BBU/REC/RCC/C-RAN/V-RAN, O-RAN, or part thereof. A DU may also be called RRH/RRU/RE/RU, or part thereof.

A DU supports one or multiple cells, and could thus serve as e.g. a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021-06) sections 42.1 and 4.4).

A UE is e.g. either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if
data is scheduled for the data channel;
provide channel quality and feedback information; and/or
perform neighbouring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps; and/or
measurement reporting.

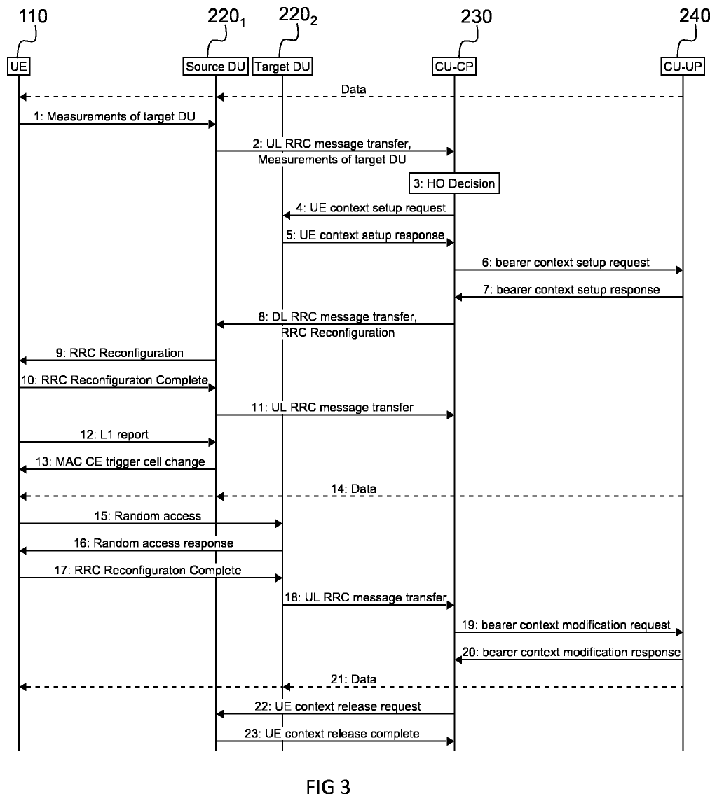

FIG. 3 illustrates an example of message exchange for L1/L2 based inter cell mobility (also referred to as: L1/2 Centric Mobility, L1/2 inter cell mobility and Lower Layer Mobility, LLM).

In L1/L2 based inter cell mobility, a handover decision (e.g. about a cell change such as changing a UE 110 from a serving cell, served by a serving DU “Source DU” 220₁, to a target cell) is made by the Source DU based L1 measurements (e.g. received from a UE) and the command to carry out the hand over is effected by L2 signaling (e.g. a MAC CE to trigger the hand over) from the Source DU to the UE (wherein the UE has been pre-configured for the hand over to a target cell but configured to await the Source DU's command/trigger to complete the hand over). In this regard, the inter cell mobility is based on L1 measurements and is triggered by L2 signaling (hence such mobility is referred to as “L1/L2” based inter cell mobility).

In the handover scenario depicted in the message exchange of FIG. 3, the hand over is to a target cell of a Target DU 220₂. However, it is to be appreciated that in other scenarios, the target cell could be a cell of the Source DU itself 220₁ (such that, in effect, the Target DU is the Source DU).

In this scenario, the UE 110 has established a connection to the RAN and, initially, is served by a Source DU 220₁.

In block 1, the UE 110 provides, to the Source DU 220₁, L3 measurements of a Target DU, e.g. measurements of one or more beams of one or more target cells of the Target DU.

In block 2, the L3 measurements are forwarded by the Target DU a CU-CP 230 via UpLink, UL, RRC message transfer.

In block 3, the CU-CP performs a handover, HO, decision based on the L3 measurements and makes a decision about cell preparation.

In block 4, the CU-CP proceeds to set up a context in the Target DU, via a UE context setup request message.

In block 5, the Target DU responds by sending a UE context setup response message to the CU-CP.

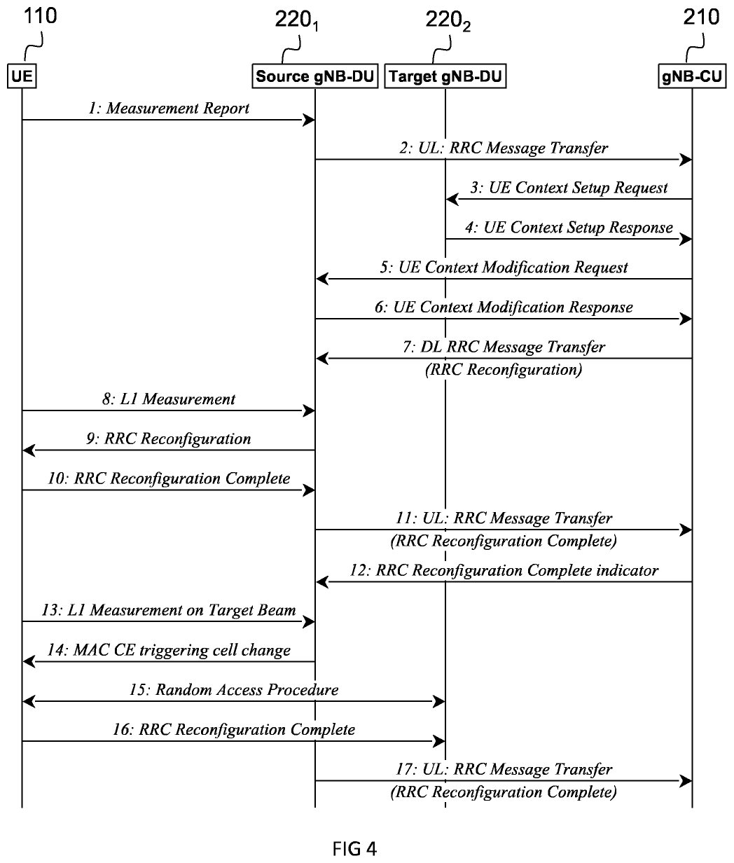

As part of the preparation for the handover, the Source DU may be configured to receive the UE's L1 measurements for the newly prepared target cell of the target DU. In the regard, the Source DU may receive a UE Context Modification Request from the CU, wherein the UE context modification request comprises configuration information for requesting/enabling the Source DU to change at least a part of the Source DU's lower layer configuration, e.g. a configuration of its layer 1 and/or layer 2 configuration/protocol(s). The UE Context Modification Request can be used to encapsulate an RRC message which the Source DU subsequently transmits to the UE (the Source DU may transmit an RRC Reconfiguration towards the UE after receiving it from the CU within a UE Context Modification Request). The sending of a UE Context Modification Request from the CU to the Source DU and the Source DU's response to the CU regarding the same are not shown in FIG. 3 (but are shown and discussed below with respect to blocks 5 and 6 of FIG. 4)

In block 6, CU-CP communicates with a CU-UP 240 to perform a bearer context setup by sending a bearer context setup request message.

In block 7, the CU-UP replies with a bearer context setup response message.

In block 8, the CU-CP sends a RRC Reconfiguration message to the Source DU using DownLink, DL, RRC message transfer.

In some examples of L1/L2 based inter cell mobility, the RRC Reconfiguration message may, in effect comprises two UE configuration components, a first and second configuration component.

The first configuration component of the RRC Reconfiguration message may comprise configuration information for enabling the UE to re-configure its lower layer configuration, e.g. to reconfigure its L1 configuration such as to change the configuration of the UE's L1 measurement report. For example, the UE could be configured to change its L1 measurement reports from reporting measurements of beams of the currently serving cell to reporting measurements of both: some beams of the currently serving cell and some beams of the target cell (such measurements of beams of the target cell in the L1 measurement report would thereby be used by the Source DU to decide whether/when to trigger the UE to change cell to the target cell). In L1/L2 based inter cell mobility, the first configuration component is to be applied immediately by the UE, i.e. applied straight away following receipt of the RRC Reconfiguration message.

By way of example, the lower layer configuration could be a reconfiguration of the UE's L1 measurements and L1 beam reports, for instance so that, rather than associating SSB indexes 0 to L-1 (where L=number of beams of cell, e.g. 6) with beam measurements for beams 1 to L of the serving cell, instead:
SSB indexes 0 to X-1 could be associated with X beams of the serving cell, and
SSB indexes 0 to X to L-1 could be associated with Y beams of the target cell.

In some examples, there could be two or more target cells (and/or two or more target DUs respectively for the same). By way of example, the L1 reconfiguration could be to associate SSB indexes:
a) 0 to 1 with beam measurements for 2 beams of the serving cell
b) 2 to 3 with beam measurements for 2 beams of a first target cell of a first target DU
c) 4 to 5 with beam measurements for 2 beams of a second target cell of a second target DU.

The second configuration component of the RRC Reconfiguration message may comprise configuration information, the application of which is to be delayed until triggered upon DU's command, for the UE to switching from a currently servicing source cell to a target cell. In L1/L2 based inter cell mobility, the second configuration component is not to be applied immediately by the UE upon receipt of the RRC Reconfiguration message, but instead it to be applied only when subsequently triggered to do so by the Source DU (i.e. via L2 signaling/the MAC CE of in block 13). When duly triggered, the UE applies the second configuration component and proceed to perform a Random Access procedure (in blocks 15 to 17) to the target cell.

In block 9, the Source DU forwards RRC Reconfiguration message to the UE.

In block 10, the UE, having applied the first configuration component and duly changing its lower layer configuration, responds to the RRC Reconfiguration message with an RRC Reconfiguration complete message which is forwarded, in block 11, to the CU-CP.

In block 12, the UE, sends periodic L1 reports to the Source DU based on the configuration (i.e. lower layer configuration change) provided in block 9, for example such that the UE's L1 beam measurement reports include measurements of one or more beams of the target cell of the Target DU.

In block 13, once the Source DU decides, based on the received L1 measurement report (i.e. L1 signaling), that the UE should be handed over to another cell (i.e., the target cell of the Target DU), the Source DU triggers L1/L2 based inter-cell mobility by sending a MAC CE (i.e. L2 signaling) to the UE. Up to this point the UE receives data from the Serving DU, as indicated in block 14.

Responsive to the MAC CE, the UE applies the RRC configuration for the target cell (i.e., Target DU) indicated by the MAC CE, and performs Random Access, RA, procedure to the Target DU, as indicated by blocks 15 and 16.

In block 17, after the RA procedure, the UE transmits an RRC Reconfiguration Complete message to the Target DU, which is forwarded to the CU-CP via UL RRC message transfer in block 18.

In block 19 and 20, the CU-CP performs bearer modification with the CU-UP to update the bearer setup and for the CU-UP to start forwarding data to the Target DU (and stop forwarding data to the Source DU). This is effected via the bearer context modification request message from the CU-CP to the CU-UP in block 19, and the bearer context modification response message from the CU-UP to the CU-CP in block 20. Once this is completed the UE starts receiving data from the Target DU as indicated in block 21.

In block 22, the CU-CP releases the UE context from the Source DU with a UE Context Release Request message, to which the Source DU replies with a UE Context Release Complete message.

In some examples, L1/L2 based inter cell mobility (i.e. its mechanism and procedures) may provide a way to reduce: latency, overhead and (service) interruption time in inter cell mobility.

In some examples, L1/2 based inter cell mobility may provide:
configuration and maintenance for multiple candidate target cells to allow fast application of configurations for candidate target cells;
a dynamic switch mechanism among candidate serving cells (including special cell, SpCell, and secondary cell, SCell) for potential applicable scenarios based on L1/L2 signalling;
L1 enhancements for inter-cell beam management, including L1 measurement and reporting, and beam indication;
Timing Advance management; and
CU-DU interface signaling to support L1/L2 based inter cell mobility

The procedure of L1/L2 based inter-cell mobility may be applicable to the following scenarios:
Standalone, CA, and NR-DC cases with serving cell change within one carrier group, CG
Intra-DU case, intra-CU case, and inter-DU case (applicable for Standalone and CA)
Both intra-frequency and inter-frequency
Both FR1 and FR2
Source and target cells may be synchronized or non-synchronized

FIG. 4 illustrates a further example of message exchange for L1/L2 based inter cell mobility (broadly similar to that of FIG. 3), wherein a serving/Source DU makes a handover decision about a cell change based on L1 signaling (namely L1 measurement reports) and the Source DU triggers the cell change via L2 signaling (namely a MAC CE).

In blocks 1-4, the CU 210 decides on the preparation of a target cell, controlled by a target DU 220₂, for lower layer mobility based on measurements reports from the UE, forwarded on to CU by the Source DU 220₁. Blocks 1, 2, 3, and 4 broadly correspond to blocks: 1, 2, 4 and 5 of FIG. 3.

As part of the preparation, the Source DU is configured, in blocks 5-6, to receive the UE's L1 measurements for the newly prepared target cell of the target DU (equivalent blocks are not shown in FIG. 3, but may be present). In the regard, the Source DU receives a UE context modification request from the CU, wherein the UE context modification request comprises configuration information for requesting/enabling the Source DU to change at least a part of the Source DU's a lower layer configuration.

Block 7 broadly corresponds to block 8 FIG. 3.

In block 8, the UE sends an L1 measurement report, wherein the configuration of the L1 measurement report is in accordance with the lower layer configuration received in the last RRC reconfiguration that the UE had previously received from the network/CU (i.e. prior to the receipt of a new RRC Reconfiguration of block 9).

In block 9, the UE receives a new RRC Reconfiguration from the network/CU indicating the preparation of new target cell of a Target DU for L1/L2 based inter cell mobility. The RRC Reconfiguration also requests the UE to change at least part of the UE's lower layer configuration, e.g. configuring the UE to report at least some L1 measurements for the newly configured target cell.

In block 10, the UE sends an RRC Reconfiguration Complete message to the DU which forwards it to the CU in block 11.

In block 12, the CU sends the DU an RRC Reconfiguration complete indicator.

Meanwhile, in block 13, the UE starts to send L1 measurement reports using the new RRC reconfiguration that it received from the network/CU in block 9.

A problem with conventional L1/L2 based inter cell mobility, is that the Source DU does not know exactly when UE applies the new RRC Reconfiguration of block 9, i.e. the Source Du does not know when the UE has changed its lower layer configuration as per the RRC

Reconfiguration message of block 9 (it being noted that RRC messaging is effectively “transparent” to the Source DU, i.e. the Source DU is unaware of the content of RRC messages and hence the Source DU is unaware that the UE has applied the reconfiguration via the UE's RRC Reconfiguration Complete message of block 10). Therefore, the Source DU cannot determine whether the received L1 Measurement report in block 13 follows the new RRC reconfiguration of block 9 or a previous RRC Reconfiguration. As such, the Source DU may misinterpret the UE's L1 measurement report of block 13 of FIG. 4, i.e. misinterpret the radio measurements and the SSB resource indicators that are included in the L1 measurement report of block 13. Since the Source DU makes a handover decision based on the L1 measurement report, any misinterpretation of the L1 measurement report can lead to the Source DU making an erroneous or sub-optimal handover decision.

Whilst is may be possible to make a reconfiguration “with sync” in blocks 9-10, this would require the use of random access towards the serving DU and the resting of PCDP and RLC layers. Performing random access after each RRC Reconfiguration and resetting the protocol layers would lead to delay and interruption time, which undermine the objective of L1/L2 based inter-cell mobility.

Various examples of the present disclosure seek to address such issues in L1/L2 based inter-cell mobility.

Certain examples of the disclosure, provide a method for ensuring synchronisation of an applied L1/L2 configuration in a UE (e.g. following the RRC Reconfiguration message of block 9 of FIGS. 4) and L1/L2 configuration in a DU (e.g. following the UE Context Modification Request message of block 5 of FIG. 4).

In various examples of the disclosure, when the CU requests a modification of UE context involving a change in a lower layer configuration, the UE context modification request that the CU sends in this regard is identified by an identifier, ID, and the ID is included the in the UE context modification request. In this regard, the CU generates an ID that identifies the request and communicates the ID to the Source DU and to the UE.

The DU may send a UE context modification response to the CU which includes the ID. The CU may send an RRC reconfiguration message to the UE (via the DU). This RRC Reconfiguration includes the ID that is generated by the CU (and which was also communicated to the Source DU).

This RRC-Reconfiguration may also include an indicator requesting the UE to confirm, to the DU, that the UE has performed the requested lower layer configuration change. In this regard, such an indicator may be a flag that signifies that ‘L1-sync is needed’ and that the ID is to be sent by the UE, e.g. via L1 signaling. The inclusion of the ID in the RRC-Reconfiguration can be implicitly considered as triggering activation for L1-sync. In other words, the presence of the ID itself in the RRC Reconfiguration could serve as the indicator.

In examples of the disclosure, responsive to the UE applying the new RRC reconfiguration and completing the reconfiguration of its lower layer protocol, the UE sends L2 or L1 signaling (e.g. a MAC CE or an L1 signal such as L1 measurement report) which including the received ID, in order to inform the DU that the UE has applied the new lower layer configuration.

In some examples, the ID can be flag or single bit identifier signalled over an existing L1 uplink control channel indication (i.e. instead of the ID being a multibit/long identifier). This method can be used if the CU is only preparing single target DU configuration for L1/L2 based inter cell mobility operation and ensures that no other reconfigurations are applied after the L1/L2 based inter cell mobility configuration.

In some examples, the ID can be included, by the UE, in the L1 measurement report (e.g., Channel State Information, CSI, Report) after applying the new RRC Reconfiguration. The L1 indication may be included always (e.g. in each L1 measurement report) or only once after the UE has applied the new RRC Reconfiguration.

Similar to the baseline/conventional L1/L2 based inter cell mobility operation (show in FIG. 3), after successfully applying the lower layer configuration using the new RRC configuration, in examples of the present disclosure, the UE can also send a RRC Reconfiguration-complete message to the Source DU which forwards the same to the CU.

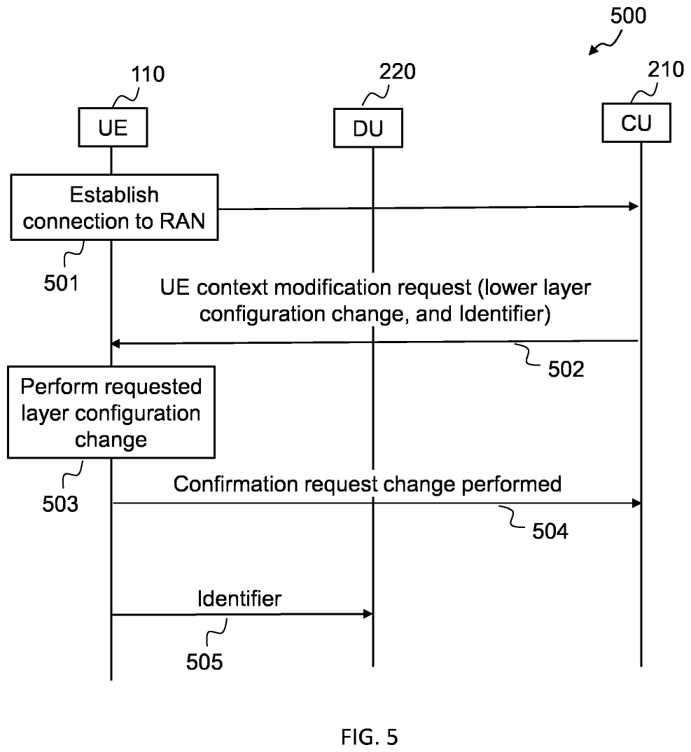

FIG. 5 illustrates a signaling diagram showing the exchange of signals/messages (between: a UE 110, a source gNB-DU “DU” 220, and gNB-CU “CU” 210) for use in L1/L2 based inter-cell mobility according to an example of the present disclosure.

One or more of the features discussed in relation to FIG. 5 can be found in one or more of the other FIGS. During discussion of FIG. 5, reference will be made to other FIGS for the purposes of explanation.

In the example of FIG. 5, the UE is configured for accessing a RAN, wherein the RAN comprises at least a CU (which may also be referred to herein as a “central node”) and a DU serving the UE (which may also be referred to herein as a “distributed node”), and wherein the central node controls the distributed node.

The UE comprises means configured to (e.g. at least one processor; and at least one memory storing instructions that, when executed by the at least one processor, cause the UE at least to perform the following:) establish a connection towards the radio access network, as indicated by block 501.

The UE is further configured to receive, from the central node, a UE context modification request, as indicated by block 502. The UE context modification request comprises:
a request to change at least part of a lower layer configuration, and
an identifier related to the request (e.g. an identifier that identifies the request,
wherein such an identifier may be generated by the CU and previously assigned/associated with the request).

Block 502 is somewhat similar the blocks 8 and 9 of FIG. 3, and blocks 7 and 10 of FIG. 4, albeit the UE context modification request of block 502 further comprises the identifier.

The UE is further configured to perform the requested change of the lower layer configuration, as indicated by block 503.

Based at least in part on the performance of the requested lower layer configuration change (e.g. in response to applying/completing the requested lower layer configuration change), the UE is configured to:

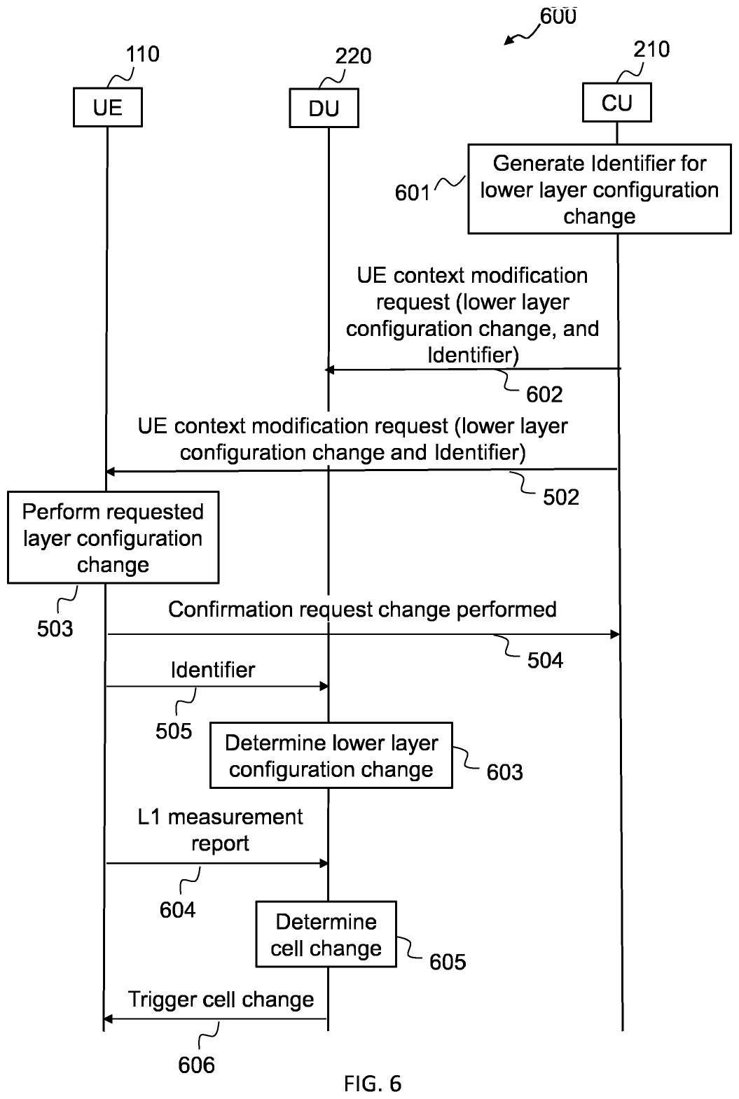

transmit, towards the central node, a confirmation that the requested change has been performed, as indicated by block 504 (thereby informing the CU that the requested lower layer configuration has been performed/completed-block 504 is somewhat similar the blocks 10 and 11 of FIG. 3 and blocks 10 and 11 of FIG. 4); and transmit, towards the distributed node, the identifier, as indicated by block 505 (which, as will be discussed with respect to FIG. 6, the DU can use to determine that the requested lower layer configuration has been performed/completed).

In some examples, the UE context modification request is received from the central node in, at least one selected from the group of:
a layer 3 protocol message;
a Radio Resource Configuration, RRC, message; and
an RRC Reconfiguration message.

In some examples, the identifier is transmitted towards the distributed node, at least one selected from the group of:
via layer 2 signaling;
in a layer 2 protocol message; and
in a Medium Access Control, MAC, Control Element, CE.

In some examples, the identifier is transmitted towards the distributed node, at least one selected from the group of:
via layer 1 signaling;
in Uplink Control Information, UCI;
in a Channel State Information, CSI, report; and
in a layer 1 measurement report.

In some examples, the identifier is transmitted towards the distributed node in:
one or more layer 1 measurement reports at least one selected from the group of: via layer 1 signaling;
in Uplink Control Information, UCI (e.g. send via Sent via an Uplink Control Channel, such as a Physical Uplink Control Channel, PUCCH);
in a Channel State Information, CSI, report; and
in a layer 1 measurement report (such as a layer 1 beam measurement report).

In some examples, the UE context modification request comprises an indicator for requesting the UE to confirm, to the distributed node, that the UE has performed the requested change; and the UE is further configured to transmit, based at least in part on the received indicator, the identifier towards the distributed node for confirming to the distributed node that the UE has performed the requested change.

In some examples, the indicator is: a flag or the identifier (i.e. the identifier itself serves as the indicator).

In some examples, the identifier is:
an identifier for identifying the request (e.g. an identifier generated by the CU that has been associated with/assigned to the request);
a multibit identifier; or
a flag.

In some examples, the UE context modification request is a request for use in a hand over procedure for handing over the UE from a currently serving cell to another cell (either controlled by the DU or not). In some examples, the UE context modification request is a request for use in an L1/L2 based inter-cell mobility procedure for switching the UE between cells.

In some examples, the requested change in lower layer configuration comprises a request for the UE to, at least one selected from the group of:
reconfigure the UE's lower layer protocol;
adjust a Layer 1, L1, measurement performed by the UE;
re-configure an L1 measurement report of the UE;
measure one or more beams of a target cell; and
report one or more measurements of one or more beams of a target cell.

FIG. 6 illustrates a signaling diagram showing the exchange of signals/messages (between: a UE 110, a source gNB-DU “DU” 220, and gNB-CU “CU” 210) for use in L1/L2 based inter-cell mobility according to a further example of the present disclosure.

One or more of the features discussed in relation to FIG. 6 can be found in one or more of the other FIGS. During discussion of FIG. 6, reference will be made to other FIGS for the purposes of explanation.

In block 601, the CU generates an identifier, ID, associated with a request to change at least part of a lower layer configuration. For instance, the ID is configured to identify the request and the CU assigns/associates the ID to the request.

In block 602, the CU transmits, towards the distributed node, a first UE context modification request. The first UE context modification request comprises:
the request to change at least part of a lower layer ((i.e. for the DU to change its lower layer configuration), and
the identifier.

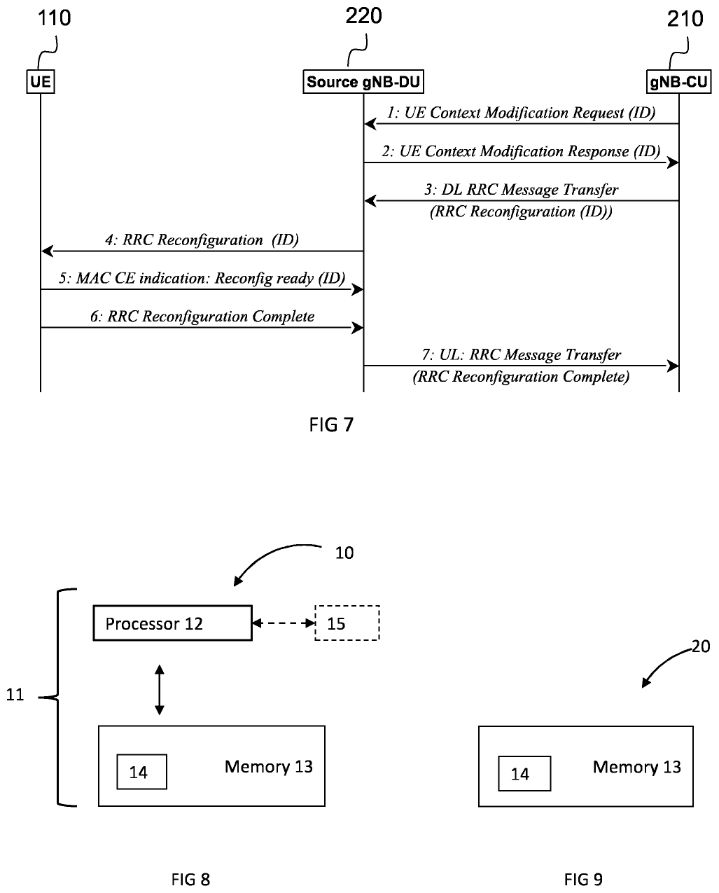

Block 602 is somewhat similar to block 5 of FIG. 4, albeit the first UE context modification request of block 602 further comprises the identifier. Responsive to receipt of the UE context modification, the DU may transmit a response to the CU (similar to block 6 of FIG. 4 albeit the response may further comprise the identifier [i.e. as per block 2 of FIG. 7]), and the DU may apply the requested change to its lower layer configuration.

In some examples, the first UE context modification request comprises: a request to, at least one or more of:
reconfigure the UE's lower layer protocol.
adjust an interpretation of a Layer 1, L1, measurement report received from the UE;
receive, from the UE, L1 measurements for a target cell;
associate one or more measurements, from a measurement report received from the UE, with of one or more beams of a target cell; and
hand over the UE to at least one selected from the group of:
a target cell controlled by the DU;
a target cell controlled by another DU; and
one or more candidate target cells (one of more of which may be controlled by the DU).

In some examples, the first UE context modification request comprises a plurality of requested changes to one or more lower layer configurations, and
the identifier is configured to identify the plurality of requested changes, or
the identifier comprises a plurality of identifiers configured to identify the plurality of requested changes respectively.

In some examples, the distributed node is configured to:
adjust an interpretation of a Layer 1, L1, measurement report received from the UE based at least in part on the identifier received from the central node; and/or
associate one or more measurements, from a measurement report received from the UE, with of one or more beams of a target cell based at least in part on the identifier received from the central node.

Responsive to completion of the requested lower layer configuration change, the DU may transmit, towards the CU, confirmation that the requested change has been performed (not shown). The response to the first UE context modification request may comprise the identifier or a replacement identifier for identifying the request (for instance if the DU were already using the initially proposed identifier generated by and received from the CU. Such a replacement identifier could be used instead of the identifier generated by the CU in the subsequent blocks).

In block 502, the CU transmits, towards the UE, a second UE context modification request which comprises:
a request to change at least part of a lower layer configuration (i.e. for the UE to change its lower layer configuration), and
the identifier.

Blocks 503 to 505 are the same as block 503 to 505 of FIG. 4.

In block 603, the DU determines, based at least in part on the identifier received from the UE in block 505, whether the UE has performed the requested change. In this regard, since the UE only sends the identifier in response to completing the requested change, the DU can determine that the requested lower layer configuration has been completed based on matching the identifier received from the UE in block 505 with the identifier received from the CU in block 602.

In block 604, the UE sends an L1 measurement report in accordance with the lower layer reconfiguration received in block 502.

Following on from the determination of block 605, the DU is able to determine that L1 measurement report is in accordance with the lower layer reconfiguration received in block 502. In this regard, the lower layer reconfiguration received in block 502 can be a request for the UE to: one or more of:
adjust a Layer 1, L1, measurement performed by the UE;
re-configure an L1 measurement report of the UE;
measure one or more beams of a target cell (or one or more candidate target cells); and
report one or more measurements of one or more beams of a target cell (or one or more candidate target cells).

Accordingly, the DU is able to determine whether the L1 measurements received from the UE are to be associated with at least one selected from the group of:
a target cell;
one or more candidate target cells;
one or more beams of a target cell; and
one or more beams of one or more candidate target cells.

The DU can be configured to determine to trigger the UE to execute a handover of the UE to a target cell, based at least in part on at least one selected from the group of:
the identifier received from the UE; and
an L1 measurement report received from the UE following receipt of the identifier from the UE.

In block 605, the DU determines whether or not to change/switch the UE's serving cell to the target cell. This determination is based, at least in part on the received identifier in block 505 as well as the subsequently received L1 measurement report of block 604.

Since the DU is able to determine, based at least in part on the identifier received from the UE in block 505, that the UE has performed the requested change, the DU can ascertain that the L1 measurement report received in block 604 is in accordance with the is lower layer reconfiguration of the recent UE context modification request (i.e. as compared to the L1 measurement report being in accordance with an earlier/previously received lower layer configuration that was received before the UE context modification request of block 502). Advantageously, the DU thereby knows that both itself (following block 602) and the UE (following block 502) have applied respective lower layer reconfigurations, and hence that the DU's lower layer reconfiguration is ‘in-sync’ with the UE's lower layer reconfiguration. Advantageously, this can avoid/reduce the risk of the DU misinterpreting the L1 measurement report of block 604. Moreover, since the DU makes a handover decision to determine a cell change/switch based on L1 measurement reports, this can avoid/reduce the DU making an erroneous or sub-optimal handover decision.

In block 606, following the DU's determination of block 605 to change the UE's serving cell to the target cell, the DU triggers the UE to execute a handover of the UE to the target cell.

FIG. 7 illustrates message flow (between: a UE 110, a source gNB-DU “DU” 220, and gNB-CU “CU” 210) for use in L1/L2 based inter cell mobility in accordance with an example of the present disclosure.

In block 1, the CU requests a modification of UE context involving Lower Layer (e.g. a layer 1 reconfiguration request) by sending a UE Context Modification Request to the DU. This request is identified by an ID. The DU stores a previous layer 1 configuration of the UE, until the UE indicates that it has switched to the new L1 configuration (i.e. in block 5 as discussed below).

In block 2, responsive to the UE Context Modification Request received from the CU, the DU sends a UE Context Modification Response to the CU. The ID may be included in this message. Also, if the DU determines that the ID received from the CU is already in use by the DU, the DU can generate its own replacement ID for identifying the request and send the replacement ID to the CU, e.g. in the UE Context Modification Response of block 2.

In block 3, the CU generates an RRC Reconfiguration message, including the ID, and sends it, via DL RRC message transfer, to the UE via the DU.

In block 4, the RRC Reconfiguration message is forwarded by the DU to the UE.

In block 5, once the UE has applied the requested reconfiguration, the UE sends a MAC CE indication for indicating that it has applied the changed requested in the message of block 4. The ID is included in the MAC CE.

Using the ID reported by the UE in block 5, the DU matches this ID to the ID the DU received from the CU in the Context Modification Request of block 1 so as to thereby determine that the UE has applied the requested lower layer reconfiguration and has switched its L1 configuration.

As an alternative to sending the ID via layer 2 signaling such as a MAC CE in block 5, in other examples, the ID can be sent by the UE in Uplink Control Information, UCI, that contains a Channel State Information, CSI, report (for example the ID could be included in an L1 beam measurement report—not shown), thereby conserving resources by reducing/saving MAC CE signaling.

In block 6, having applied the RRC Reconfiguration, the UE replies to the CU by sending an RRC Reconfiguration Complete message to the CU via the DU.

In block 7, the DU forwards the RRC Reconfiguration Complete message, via UL RRC message transfer, to the CU.

In some examples, the ID/L1 indication can be single bit signalled over an existing L1 uplink control channel (rather than the ID/L1 indication being a multibit/long identifier). This could be done if the CU is only preparing a single target configuration for the L1/L2 based inter-cell mobility operation, and it ensures/requires that no other reconfigurations are applied after the configuration for the L1/L2 based inter-cell mobility operation.

If the UE were not requested to send an L2 or L2 indication (i.e. not requested, via the message of blocks 3 and 4 to send either: an L2/MAC CE indication or L1 indication in block 5), the ID could be omitted in the RRC Reconfiguration message of blocks 3 and 4, and hence no L2 or L1 indication would be sent in block 5.

Advantageously, the process of FIG. 7 may avoid/reduce the DU misinterpreting L1 measurement report subsequently received from the UE, and accordingly the DU can decide properly on the correct/optimal lower layer mobility decision to trigger the UE to switch cells (as per blocks 604 to 606 of FIG. 6). The process of FIG. 7 many ensure that the UE and DU are in sync with respect to the use of the new lower layer reconfigurations (i.e. the reconfigurations for L1/L2 based inter-cell mobility).

The signal diagrams of FIGS. 3 to 7, can be considered to illustrate a plurality of methods in the sense that they can be considered to illustrate one or more actions performed by/at a plurality of actors/entities (e.g.: UE 110, DU 220 and CU 210). These figures can therefore be considered to illustrate a plurality of individual methods performed by each respective individual actor/entity. These figures can also be considered to illustrate the transmission/communication/sending/receiving of various signals/messages/information (directly or indirectly) between the actors/entities. Furthermore, for any transmitting/causing transmission feature(s)/action(s) illustrated in these figures, they can also be considered to illustrate the corresponding receiving/causing receiving feature(s)/action(s).

Various component blocks illustrated in the figures can be functional and the functions described in each block can be performed by a single physical entity (such as a: UE, DU and CU, and a duly configured apparatus is described with reference to FIG. 8). The functions described can also be implemented by a computer program (such as is described with reference to FIG. 9). Accordingly, the blocks illustrated in signal diagrams of FIGS. 3 to 7 can represent actions in a method, functionality performed by an apparatus, and/or sections of instructions/code in a computer program.

The signal diagrams of FIGS. 3 to 7 each represent a possible scenario among others. The order of the blocks shown is not absolutely required, so in principle, certain of the blocks can be performed out of order (not least for example the order of block 504 and 505 in FIGS. 5 and 6 could be reversed).

It will be understood that each block and combinations of blocks illustrated in FIGS. 3 to 7, as well as the further functions described above, can be implemented by various means, such as hardware, firmware, and/or software including one or more computer program instructions. For example, one or more of the functions described above can be performed by a duly configured apparatus (such as: a UE, DU or CU comprising means for performing the above-described functions). One or more of the functions described above can be embodied by a duly configured computer program (such as a computer program comprising computer program instructions which, when executed by an apparatus, cause the apparatus to perform the functions described above. The computer program instructions can be stored in a memory storage device and performed by a processor.

As will be appreciated, any such computer program instructions can be loaded onto a computer or other programmable apparatus (i.e., hardware) to produce a machine, such that the instructions when performed on the programmable apparatus create means for implementing the functions specified in the blocks. These computer program instructions can also be stored in a computer-readable medium that can direct a programmable apparatus to function in a particular manner, such that the instructions stored in the computer-readable memory produce an article of manufacture including instruction means which implement the function specified in the blocks. The computer program instructions can also be loaded onto a programmable apparatus to cause a series of operational actions to be performed on the programmable apparatus to produce a computer-implemented process such that the instructions which are performed on the programmable apparatus provide actions for implementing the functions specified in the blocks.

Various, but not necessarily all, examples of the present disclosure can take the form of a method, an apparatus or a computer program. Accordingly, various, but not necessarily all, examples can be implemented in hardware, software or a combination of hardware and software.

Various, but not necessarily all, examples of the present disclosure are described using flowchart illustrations and schematic block diagrams. It will be understood that each block (of the flowchart illustrations and block diagrams), and combinations of blocks, can be implemented by computer program instructions of a computer program. These program instructions can be provided to one or more processor(s), processing circuitry or controller(s) such that the instructions which execute on the same create means for causing implementing the functions specified in the block or blocks, i.e., such that the method can be computer implemented. The computer program instructions can be executed by the processor(s) to cause a series of operational blocks/steps/actions to be performed by the processor(s) to produce a computer implemented process such that the instructions which execute on the processor(s) provide steps for implementing the functions specified in the block or blocks.

Accordingly, the blocks support: combinations of means for performing the specified functions; combinations of actions for performing the specified functions; and computer program instructions/algorithm for performing the specified functions. It will also be understood that each block, and combinations of blocks, can be implemented by special purpose hardware-based systems which perform the specified functions or actions, or combinations of special purpose hardware and computer program instructions.

Various, but not necessarily all, examples of the present disclosure provide both a method and corresponding apparatus comprising various modules, means or circuitry that provide the functionality for performing/applying the actions of the method. The modules, means or circuitry can be implemented as hardware, or can be implemented as software or firmware to be performed by a computer processor. In the case of firmware or software, examples of the present disclosure can be provided as a computer program product including a computer readable storage structure embodying computer program instructions (i.e., the software or firmware) thereon for performing by the computer processor.

FIG. 8 schematically illustrates a block diagram of an apparatus 10 for performing the methods, processes, procedures and signalling described in the present disclosure and illustrated not least on FIGS. 5 to 7. In this regard the apparatus can perform the roles of: a UE 110, a DU 220, or a CU 210 in the illustrated and above-described methods. The component blocks of FIG. 2 are functional and the functions described can be performed by a single physical entity.

The apparatus comprises a controller 11, which could be provided within a device such as a UE 110, a DU 220, or a CU 210.

The controller 11 can be embodied by a computing device, not least such as those mentioned above. In some, but not necessarily all examples, the apparatus can be embodied as a chip, chip set, circuitry or module, i.e., for use in any of the foregoing. As used here ‘module’ refers to a unit or apparatus that excludes certain parts/components that would be added by an end manufacturer or a user.

Implementation of the controller 11 can be as controller circuitry. The controller 11 can be implemented in hardware alone, have certain aspects in software including firmware alone or can be a combination of hardware and software (including firmware).

The controller 11 can be implemented using instructions that enable hardware functionality, for example, by using executable instructions of a computer program 14 in a general-purpose or special-purpose processor 12 that can be stored on a computer readable storage medium 13, for example memory, or disk etc., to be executed by such a processor 12.

The processor 12 is configured to read from and write to the memory 13. The processor 12 can also comprise an output interface via which data and/or commands are output by the processor 12 and an input interface via which data and/or commands are input to the processor 12. The apparatus can be coupled to or comprise one or more other components 15 (not least for example: a radio transceiver, sensors, input/output user interface elements and/or other modules/devices/components for inputting and outputting data/commands).

The memory 13 stores a computer program 14 comprising computer program instructions (computer program code) that controls the operation of the apparatus 10 when loaded into the processor 12. The computer program instructions, of the computer program 14, provide the logic and routines that enables the apparatus to perform the methods, processes and procedures described in the present disclosure and illustrated not least in FIGS. 5 to 7. The processor 12 by reading the memory 13 is able to load and execute the computer program 14.

The computer program instructions may be comprised in a computer program, a non-transitory computer readable medium, a computer program product, a machine readable medium. In some but not necessarily all examples, the computer program instructions may be distributed over more than one computer program.

Although the memory 13 is illustrated as a single component/circuitry it can be implemented as one or more separate components/circuitry some or all of which can be integrated/removable and/or can provide permanent/semi-permanent/dynamic/cached storage.

Although the processor 12 is illustrated as a single component/circuitry it can be implemented as one or more separate components/circuitry some or all of which can be integrated/removable. The processor 12 can be a single core or multi-core processor.

The apparatus can include one or more components for effecting the methods, processes and procedures described in the present disclosure and illustrated in the figures. It is contemplated that the functions of these components can be combined in one or more components or performed by other components of equivalent functionality. The description of a function should additionally be considered to also disclose any means suitable for performing that function. Where a structural feature has been described, it can be replaced by means for performing one or more of the functions of the structural feature whether that function or those functions are explicitly or implicitly described.

Although examples of the apparatus have been described above in terms of comprising various components, it should be understood that the components can be embodied as or otherwise controlled by a corresponding controller or circuitry such as one or more processing elements or processors of the apparatus. In this regard, each of the components described above can be one or more of any device, means or circuitry embodied in hardware, software or a combination of hardware and software that is configured to perform the corresponding functions of the respective components as described above.

The apparatus can, for example, be a UE 110, a DU 220, or a CU 210. In some examples, the apparatus can be embodied as a chip, chip set, circuitry or module, i.e., for use in any of the foregoing.

In one example, the apparatus is a UE and can be embodied on a hand held portable electronic device, such as a mobile telephone, mobile communication device, wearable computing device or personal digital assistant, that can additionally provide one or more audio/text/video communication functions (for example tele-communication, video-communication, and/or text transmission (Short Message Service (SMS)/Multimedia Message Service (MMS)/emailing) functions), interactive/non-interactive viewing functions (for example web-browsing, navigation, TV/program viewing functions), music recording/playing functions (for example Moving Picture Experts Group-1 Audio Layer 3 (MP3) or other format and/or (frequency modulation/amplitude modulation) radio broadcast recording/playing), downloading/sending of data functions, image capture function (for example using a (for example in-built) digital camera), and gaming functions, or any combination thereof.

The UE can be provided in an electronic device, for example, a mobile terminal. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices can readily employ examples of the present disclosure. Furthermore, devices can readily employ examples of the present disclosure regardless of their intent to provide mobility.

In examples where the apparatus is provided within a UE 110, the apparatus comprises:
at least one processor 12; and
at least one memory 13 including computer program code
the at least one memory 13 storing instructions that, when executed by the at least one processor 12, cause the apparatus at least to:
   establish a connection towards the radio access network;
   receive, from the central node, a UE context modification request comprising:
      a request to change at least part of a lower layer configuration, and
      an identifier related to the request;
   perform the requested change of the lower layer configuration;
   transmit, towards the central node, a confirmation that the requested change has been performed; and
   transmit, towards the distributed node, the identifier.

In examples where the apparatus is provided within a distributed node 220, the apparatus comprises:
at least one processor 12; and
at least one memory 13 including computer program code
the at least one memory 13 storing instruction that, when executed by the at least one processor 12, cause the apparatus at least to:
   receive a first User Equipment, UE, context modification request transmitted from the central node towards the distributed node, the first UE context modification request comprising:
      a request to change at least part of a lower layer configuration, and
      an identifier related to the request;
   receive a second UE context modification request transmitted from the central node towards the UE via the distributed node, the second UE context modification request comprising:
      a request to change at least part of a lower layer configuration, and the identifier;
   transmit the second UE context modification request towards the UE; and receive, from the UE, the identifier.

In examples where the apparatus is provided within a central node 220, the apparatus comprises:
at least one processor 12; and
at least one memory 13 including computer program code
the at least one memory 13 storing instruction that, when executed by the at least one processor 12, cause the apparatus at least to:
   generate an identifier associated with a request to change at least part of a lower layer configuration;
   transmit, towards the distributed node, a first User Equipment, UE, context modification request comprising:
      the request to change at least part of a lower layer, and
      the identifier; and
   transmit, towards the UE, a second UE context modification request comprising:
      a request to change at least part of a lower layer configuration, and the identifier.

According to some examples of the present disclosure, there is provided a system comprising at least one UE 110, at least one DU 220 and/or at least one CU 210.

The above described examples find application as enabling components of: telecommunication systems; tracking systems, automotive systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things (IOT); Vehicle-to-everything (V2X), virtualized networks; and related software and services.

FIG. 9, illustrates a computer program 14 which may be conveyed via a delivery mechanism 20. The delivery mechanism 20 can be any suitable delivery mechanism, for example, a machine readable medium, a computer-readable medium, a non-transitory computer-readable storage medium, a computer program product, a memory device, a solid-state memory, a record medium such as a Compact Disc Read-Only Memory (CD-ROM) or a Digital Versatile Disc (DVD) or an article of manufacture that comprises or tangibly embodies the computer program 14. The delivery mechanism can be a signal configured to reliably transfer the computer program. An apparatus can receive, propagate or transmit the computer program as a computer data signal.

In certain examples of the present disclosure, there is provided a computer program comprising instructions, which when executed by an apparatus (such as a UE 110), cause the apparatus to perform at least the following or for causing performing at least the following:
establish a connection towards the radio access network;
receive, from the central node, a UE context modification request comprising:
   a request to change at least part of a lower layer configuration, and
   an identifier related to the request;
perform the requested change of the lower layer configuration;
transmit, towards the central node, a confirmation that the requested change has been performed; and
transmit, towards the distributed node, the identifier.

In certain examples of the present disclosure, there is provided a computer program comprising instructions, which when executed by an apparatus (such as a DU 220), cause the apparatus to perform at least the following or for causing performing at least the following:
receive a first User Equipment, UE, context modification request transmitted from the central node towards the distributed node, the first UE context modification request comprising:
   a request to change at least part of a lower layer configuration, and
   an identifier related to the request;
receive a second UE context modification request transmitted from the central node towards the UE via the distributed node, the second UE context modification request comprising:
   a request to change at least part of a lower layer configuration, and
   the identifier;
transmit the second UE context modification request towards the UE; and receive, from the UE, the identifier.

In certain examples of the present disclosure, there is provided a computer program comprising instructions, which when executed by an apparatus (such as a CU 210), cause the apparatus to perform at least the following or for causing performing at least the following:
generate an identifier associated with a request to change at least part of a lower layer configuration;
transmit, towards the distributed node, a first User Equipment, UE, context modification request comprising:
   the request to change at least part of a lower layer, and
   the identifier; and
transmit, towards the UE, a second UE context modification request comprising:
   a request to change at least part of a lower layer configuration, and the identifier.

References to ‘computer program’, ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this disclosure, including in any claims. As a further example, as used in this disclosure, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

Although specific terms are employed herein, they are used in a generic and descriptive sense only and not for purposes of limitation.

Features described in the preceding description can be used in combinations other than the combinations explicitly described.

Although functions have been described with reference to certain features, those functions can be performable by other features whether described or not.

Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent.

Although various examples of the present disclosure have been described in the preceding paragraphs, it should be appreciated that modifications to the examples given can be made without departing from the scope of the invention as set out in the claims. For instance, whilst examples of the present disclosure have been discussed with respect to UE handovers/cell switching (i.e. such as L1/L2 based inter-cell mobility) it is to be appreciated that examples of the disclosure are not limited to such applications/procedures and L1/L2 based inter-cell mobility, but could be applied to other applications/procedures that involve lower layer reconfiguration (such as a layer 1 or layer 2 configuration change).

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are used with an inclusive not an exclusive meaning and are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

In the above description, the apparatus described can alternatively or in addition comprise an apparatus which in some other examples comprises a distributed system of apparatus, for example, a client/server apparatus system. In examples where an apparatus provided forms (or a method is implemented as) a distributed system, each apparatus forming a component and/or part of the system provides (or implements) one or more features which collectively implement an example of the present disclosure. In some examples, an apparatus is re-configured by an entity other than its initial manufacturer to implement an example of the present disclosure by being provided with additional software, for example by a user downloading such software, which when executed causes the apparatus to implement an example of the present disclosure (such implementation being either entirely by the apparatus or as part of a system of apparatus as mentioned hereinabove).

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, block, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

1-28. (canceled)

29. User Equipment, UE, for accessing a Radio Access Network, RAN, comprising at least a central node and a distributed node, the central node controlling the distributed node, wherein the UE comprises:
at least one processor; and
at least one memory storing instructions that, when executed by the at least one processor, cause the UE at least to:
establish a connection towards the radio access network;
receive, from the central node, a UE context modification request comprising:
a request to change at least part of a lower layer configuration, and
an identifier related to the request;
perform the requested change of the lower layer configuration;
transmit, towards the central node, a confirmation that the requested change has been performed; and
transmit, towards the distributed node, the identifier.

30. The UE according to claim 29, wherein the UE context modification request is received from the central node in, at least one selected from the group of:
a layer 3 protocol message;
a Radio Resource Configuration, RRC, message; and
an RRC Reconfiguration message.

31. The UE according to claim 29, wherein the identifier is transmitted towards the distributed node, at least one selected from the group of:
via layer 2 signaling;
in a layer 2 protocol message; and
in a Medium Access Control, MAC, Control Element, CE.

32. The UE according to claim 29, wherein the identifier is transmitted towards the distributed node, at least one selected from the group of:
via layer 1 signaling;
in Uplink Control Information, UCI;
in a Channel State Information, CSI, report; and
in a layer 1 measurement report.

33. The UE according to claim 29, wherein the UE context modification request comprises an indicator for requesting the UE to confirm, to the distributed node, that the UE has performed the requested change; and wherein the UE is further configured to transmit, based at least in part on the received indicator, the identifier towards the distributed node for confirming to the distributed node that the UE has performed the requested change.

34. The UE according to claim 29, wherein the indicator is: a flag or the identifier.

35. The UE according to any previous claim, wherein the identifier is:
an identifier for identifying the request;
a multibit identifier; or
a flag.

36. The UE according to claim 29, wherein the requested change comprises a request for the UE to, at least one selected from the group of:
reconfigure the UE's lower layer protocol;
adjust a Layer 1, L1, measurement performed by the UE;
re-configure an L1 measurement report of the UE;
measure one or more beams of a target cell; and
report one or more measurements of one or more beams of a target cell.

37. A method for a User Equipment, UE, the method comprising causing, at least in part, actions that result in:
establishing a connection towards a Radio Access Network, RAN, wherein the RAN comprises at least a central node and a distributed node, the central node controlling the distributed node;
receiving, from the central node, a UE context modification request comprising:
a request to change at least part of a lower layer configuration, and
an identifier related to the request;
performing the requested change of the lower layer configuration;
transmitting, towards the central node, a confirmation that the requested change has been performed; and
transmitting, towards the distributed node, the identifier.

38. A computer program comprising instructions which, when executed by an apparatus, cause the apparatus to perform the method as claimed in method claim 37.

39. A distributed node for a Radio Access Network, RAN, comprising at least a central node and the distributed node, the central node controlling the distributed node, wherein the distributed node comprises:
at least one processor; and
at least one memory storing instructions that, when executed by the at least one processor, cause the distributed node at least to:
receive a first User Equipment, UE, context modification request transmitted from the central node towards the distributed node, the first UE context modification request comprising:
a request to change at least part of a lower layer configuration, and
an identifier related to the request;
receive a second UE context modification request transmitted from the central node towards the UE via the distributed node, the second UE context modification request comprising:
a request to change at least part of a lower layer configuration, and
the identifier;
transmit the second UE context modification request towards the UE; and
receive, from the UE, the identifier.

40. The distributed node according to claim 39, wherein the distributed node is further configured to determine, based at least in part on the identifier received from the UE, that the UE has performed the requested change.

41. The distributed node according to claim 39, wherein the distributed node is further configured to transmit, towards the central node, a response to the first UE context modification request.

42. The distributed node according to claim 41, wherein the response to the first UE context modification request comprises the identifier or a replacement identifier for identifying the request.

43. The distributed node according to claim 39, wherein the distributed node is further configured to:
receive, from the UE for transmission towards the central node, a confirmation that the requested change has been performed; and
transmit, towards the central node, the confirmation.

44. The distributed node according to claim 39, wherein the first UE context modification request comprises: a request to, at least one or more of:
reconfigure a lower layer protocol of the UE.
adjust an interpretation of a Layer 1, L1, measurement report received from the UE;
receive, from the UE, L1 measurements for a target cell;
associate one or more measurements, from a measurement report received from the UE, with of one or more beams of a target cell; and
hand over the UE to at least one selected from the group of:
a target cell controlled by the distributed node;
a target cell controlled by another distributed node; and
one or more candidate target cells.

45. The distributed node according to claim 39, wherein the first UE context modification request comprises a plurality of requested changes to the lower layer configuration, and wherein:
the identifier is configured to identify the plurality of requested changes, or
the identifier comprises a plurality of identifiers configured to identify the plurality of requested changes respectively.

46. The distributed node according to claim 39, wherein distributed node is further configured to:
adjust an interpretation of a Layer 1, L1, measurement report received from the UE based at least in part on the identifier received from the central node; and/or
associate one or more measurements, from a measurement report received from the UE, with of one or more beams of a target cell based at least in part on the identifier received from the central node.

47. The distributed node according to claim 39, wherein the distributed node is further configured to determine, based at least in part on the identifier received from the UE, whether one or more L1 measurements received from the UE are to be associated with at least one selected from the group of:
a target cell;
one or more candidate target cells;
one or more beams of a target cell; and
one or more beams of one or more candidate target cells.

48. The distributed node according to claim 39, wherein the distributed node is further configured to:
determine to trigger the UE to execute a handover of the UE to a target cell, based at least in part on at least one selected from the group of:
the identifier received from the UE; and
an L1 measurement report received from the UE following receipt of the identifier from the UE.

49. A central node for a Radio Access Network, RAN, comprising at least the central node and a distributed node, the central node controlling the distributed node, wherein the central node comprises:
at least one processor; and
at least one memory storing instructions that, when executed by the at least one processor, cause the distributed node at least to:
generate an identifier associated with a request to change at least part of a lower layer configuration;
transmit, towards the distributed node, a first User Equipment, UE, context modification request comprising:
the request to change at least part of a lower layer, and
the identifier; and
transmit, towards the UE, a second UE context modification request comprising:
a request to change at least part of a lower layer configuration, and
the identifier.

50. The central node according to claim 49, wherein the central node is further configured to:
receive, from the UE, a confirmation that the requested change has been performed.
